(19) United States
(12) Patent Application Publication
(10) Pub. No.: US 2020/0236963 A1
(43) Pub. Date: Jul. 30, 2020

(54) ICE CREAM LIFT

(71) Applicants: Patrick KINAYA, West Bloomfield, MI (US); Matthew KINAYA, West Bloomfield, MI (US); Christopher KINAYA, West Bloomfield, MI (US)

(72) Inventors: Patrick KINAYA, West Bloomfield, MI (US); Matthew KINAYA, West Bloomfield, MI (US); Christopher KINAYA, West Bloomfield, MI (US)

(21) Appl. No.: 16/260,754

(22) Filed: Jan. 29, 2019

(51) Int. Cl. A23G 9/28; B65D 85/78; A23G 9/22

(52) U.S. Cl. CPC A23G 9/287; A47J 43/282; A23G 9/222; B65D 85/78

(57) ABSTRACT

An ice cream lift including a platform that contacts and pushes up a base of an ice cream container, the platform operatively connected to a lift mechanism that drives the platform from a first position to a second higher position. A method of lifting a base of an ice cream container, by contacting the base with a platform, detaching the base from sides of the ice cream container, and driving the platform and base upwards to a higher position within the ice cream container. A container lift, comprising a platform that contacts and pushes up a base of a container, the platform operatively connected to a lift mechanism that drives the platform from a first position to a second higher position. A method of lifting a base of a container.

### BACKGROUND OF THE INVENTION

### 1. Technical Field

The present invention relates to devices and methods of serving food. More specifically, the present invention relates to devices and methods for serving ice cream in tubs.

### 2. Background Art

In restaurants and stores, ice cream is generally delivered in large tubs, and as ice cream is removed from the top of the tub, it gets harder to reach down into the tub to scoop out the ice cream. Workers risk bumping their arm against the side of the tub and have to lean into it, creating unsanitary conditions.

Several solutions to this problem have been provided in the prior art. For example, U.S. Pat. No. 1,931,366 to Woerner, et al. discloses a pan attached by two straps to a hoop that can be dropped within an ice cream can at a factory and then ice cream poured in. Once enough ice cream has been removed, a jack and ratchet can be attached at lips and to lift the pan until catches arrive at a top of the can. The device of Woerner, et al. must be used inside the ice cream can and only has two positions, and thus requires special manufacturing processes.

U.S. Pat. No. 2,266,001 to Christianson discloses a telescopic container that can be filled with ice cream. Once ice cream has been removed, it can be brought to the top of the container by rotating handles, causing worms to rise, and a spring raises the bottom of the can, and the next lower segment telescopes into the uppermost segment. The entire container rises and becomes smaller. Again, the device of Christianson require special manufacturing with his specific device.

There remains a need of a device that can aid in accessing ice cream at a bottom of a container that also works with existing ice cream containers.

### SUMMARY OF THE INVENTION

The present invention provides for an ice cream lift including a platform that contacts and pushes up a base of an ice cream container, the platform operatively connected to a lift mechanism that drives the platform from a first position to a second higher position.

The present invention provides for a method of lifting a base of an ice cream container, by contacting the base with a platform, detaching the base from sides of the ice cream container, and driving the platform and base upwards to a higher position within the ice cream container.

The present invention provides for a container lift, including a platform that contacts and pushes up a base of a container, the platform operatively connected to a lift mechanism that drives the platform from a first position to a second higher position.

The present invention also provides for a method of lifting a base of a container, by contacting the base with a platform of a container lift, detaching the base from sides of the container, and driving the platform and base upwards to a higher position within the container.

### DESCRIPTION OF THE DRAWINGS

Other advantages of the present invention are readily appreciated as the same becomes better understood by reference to the following detailed description when considered in connection with the accompanying drawings wherein:

FIG. 1 is a top perspective view of the ice cream lift;

FIG. 2 is a top view of a lift mechanism;

FIG. 3 is a top view of a lift mechanism;

FIG. 4 is a side perspective view of a lift mechanism and power source;

FIG. 5 is a side perspective view of a lift mechanism in a second higher position;

FIG. 6 is a side perspective view of a lift mechanism in a further higher position;

FIG. 7 is a side perspective view of a lift mechanism in a second higher position;

FIG. 8 is a side perspective view of a an ice cream container;

FIG. 9 is a cross-sectional view of ice cream being lifted within an ice cream container with the present invention; and

FIG. 10 is a side perspective view of a second embodiment of the ice cream lift.

### DETAILED DESCRIPTION OF THE INVENTION

Most generally, the present invention provides for devices and methods for raising the level of ice cream or any other product within a container.

Primed numbers indicate like structure amongst the several embodiments.

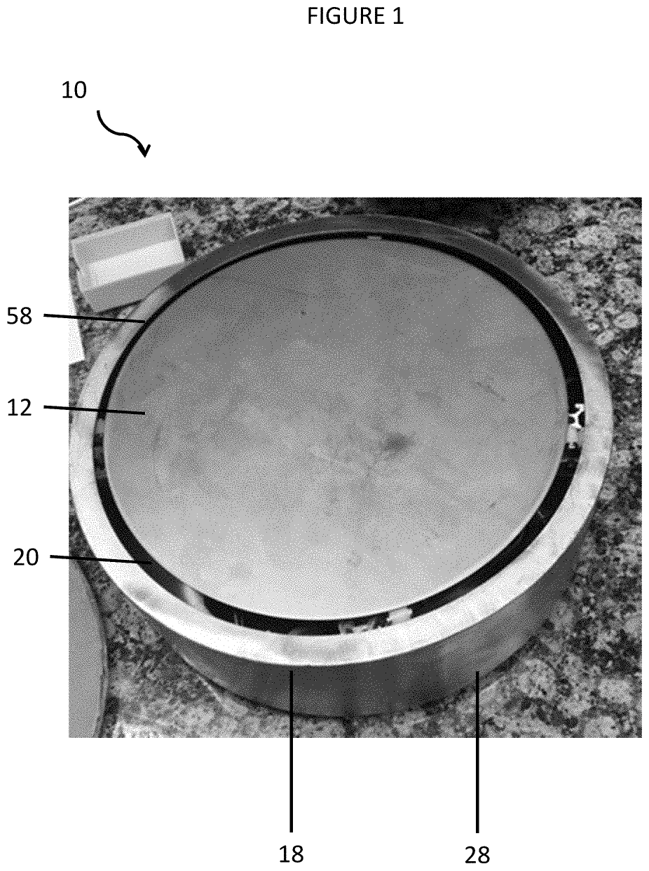

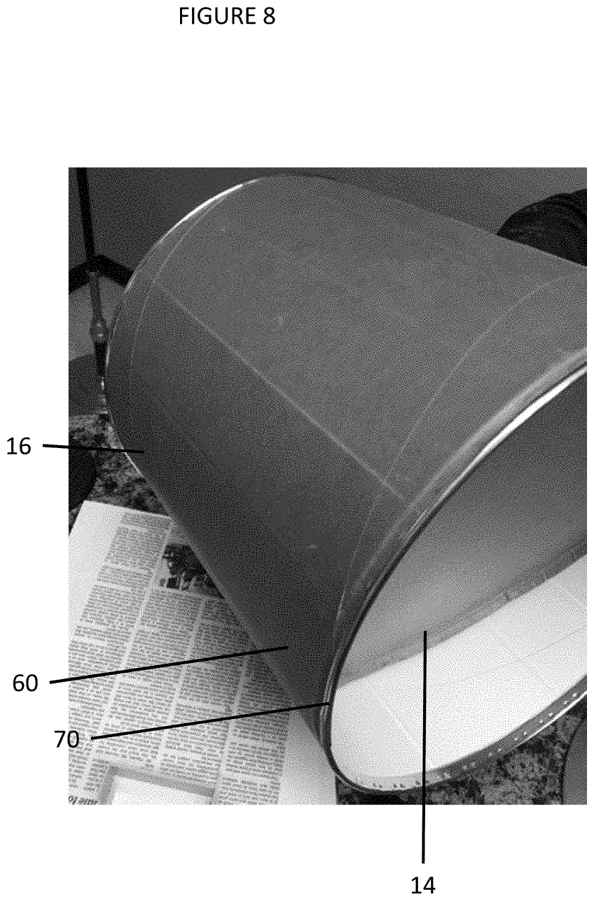

The present invention provides for an ice cream lift 10, shown in FIG. 1, including a platform 12 that contacts and pushes up a base 14 of an ice cream container 16 (shown in FIG. 8), the platform 12 operatively connected to a lift mechanism 18 that drives the platform 12 from a first position 20 to a second higher position 22.

The platform 12 can be any size to support and lift the base 14 of the ice cream container 16 sufficiently. The platform 12 is preferably flat across its surface, in a circular shape (although it can be any shape that matches the base 14, such as rectangular, oblong, or square), and can be made of metal, plastic, or any other suitable material. The platform 12 can optionally include a cutting mechanism or rim (not shown) to dissociate the base 14 away from the ice cream container 16 when pressure is applied through the lift mechanism 18. The base 14 can also include perforations around it that break the base 14 from the ice cream container 16, or the base 14 is easily releasable from the ice cream container 16 as the platform 12 is lifted as further described below.

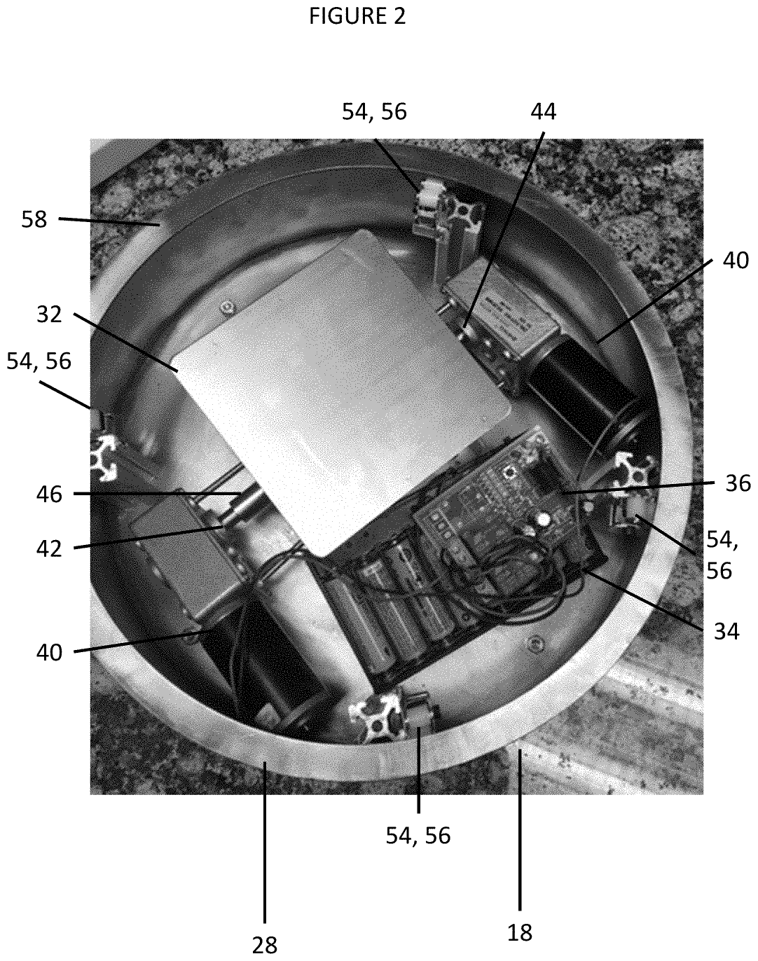

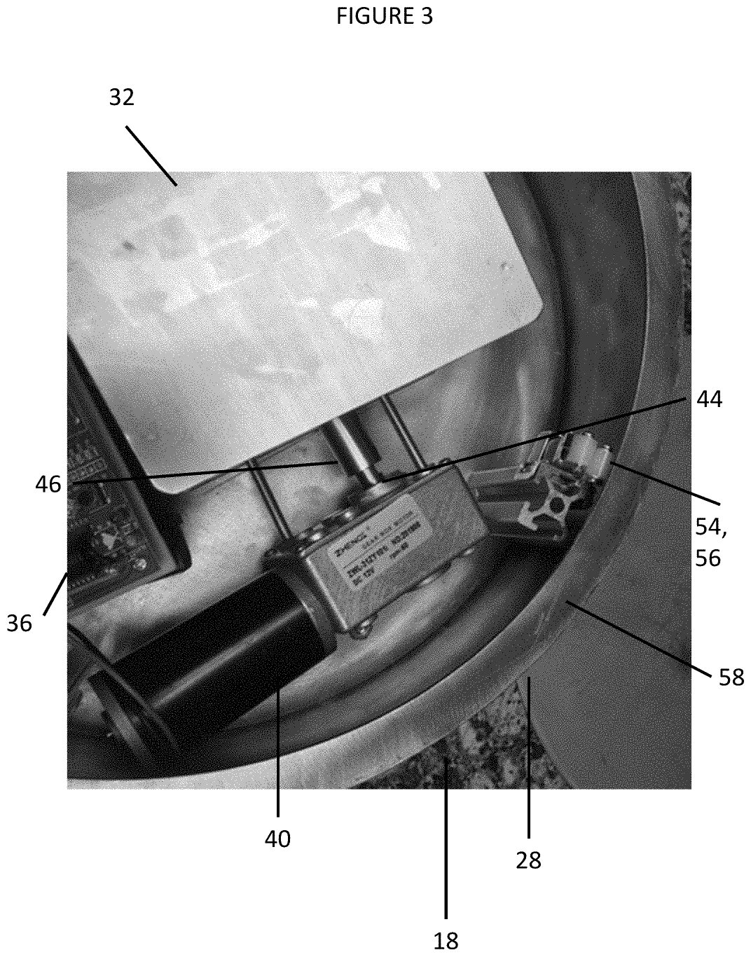

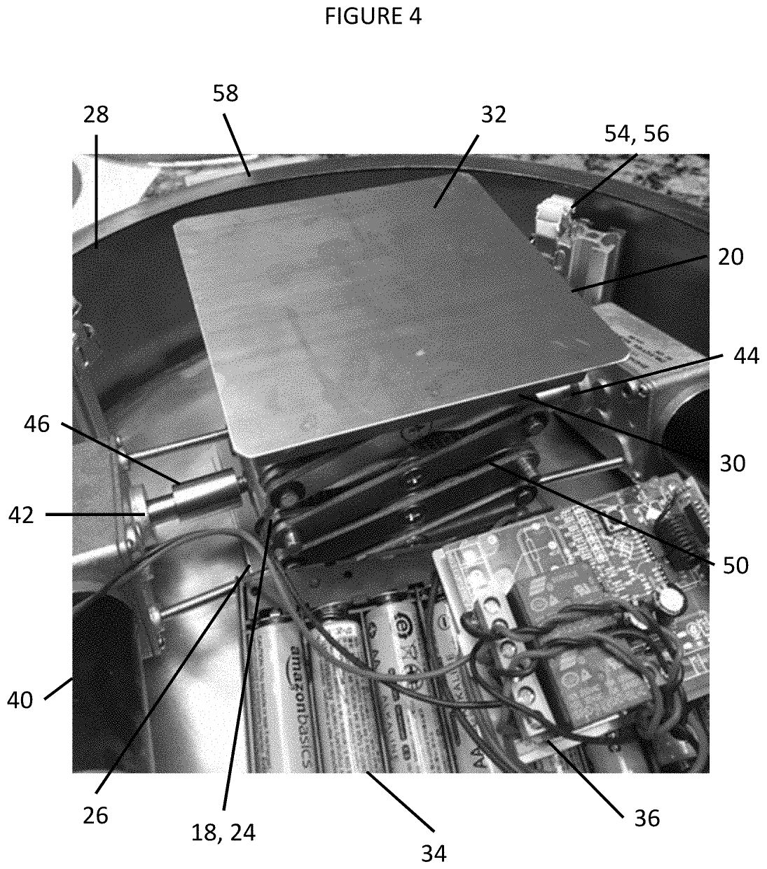

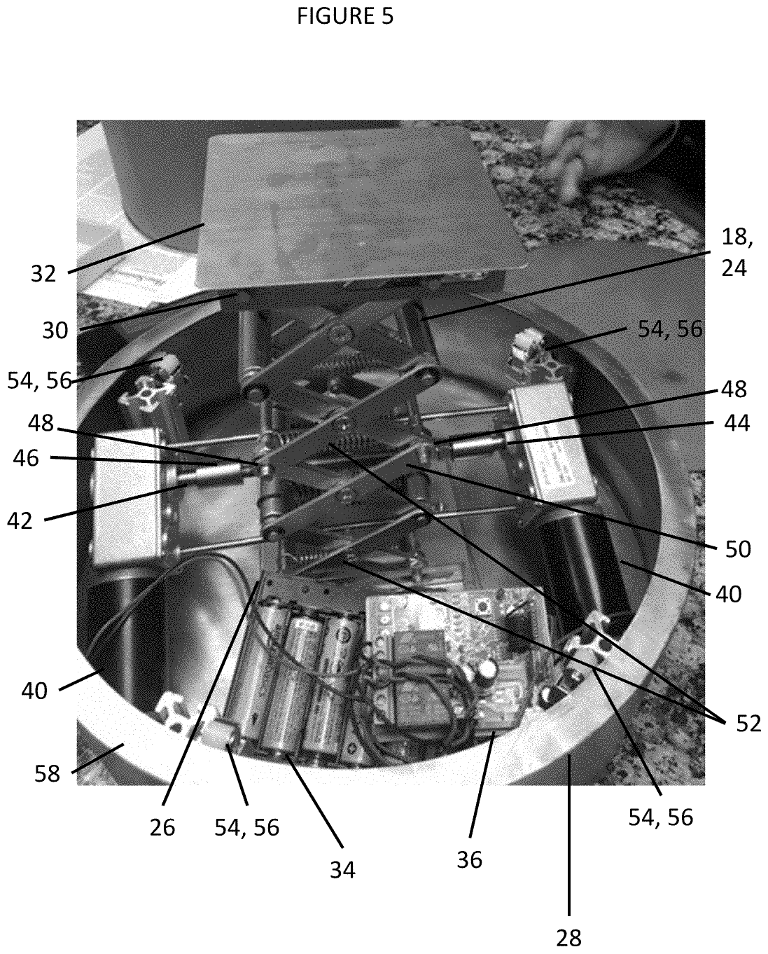

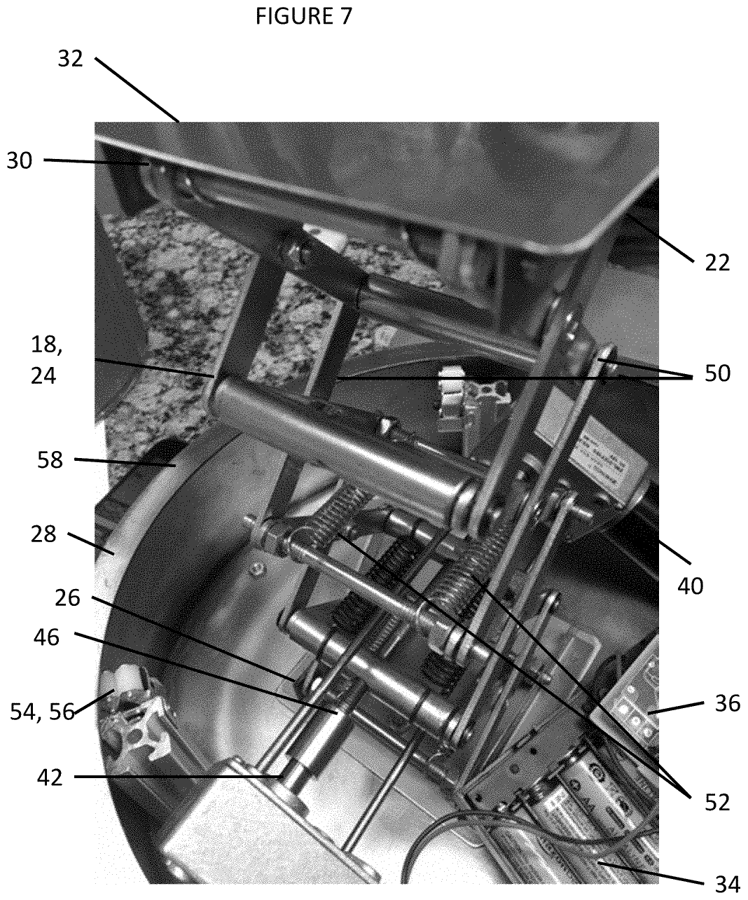

In a first embodiment, shown in FIGS. 1-7, the lift mechanism 18 is a scissor lift 24 that is operatively attached at a proximal end 26 within a housing 28, and at a distal end 30 to a support 32 that holds and contacts the platform 12.

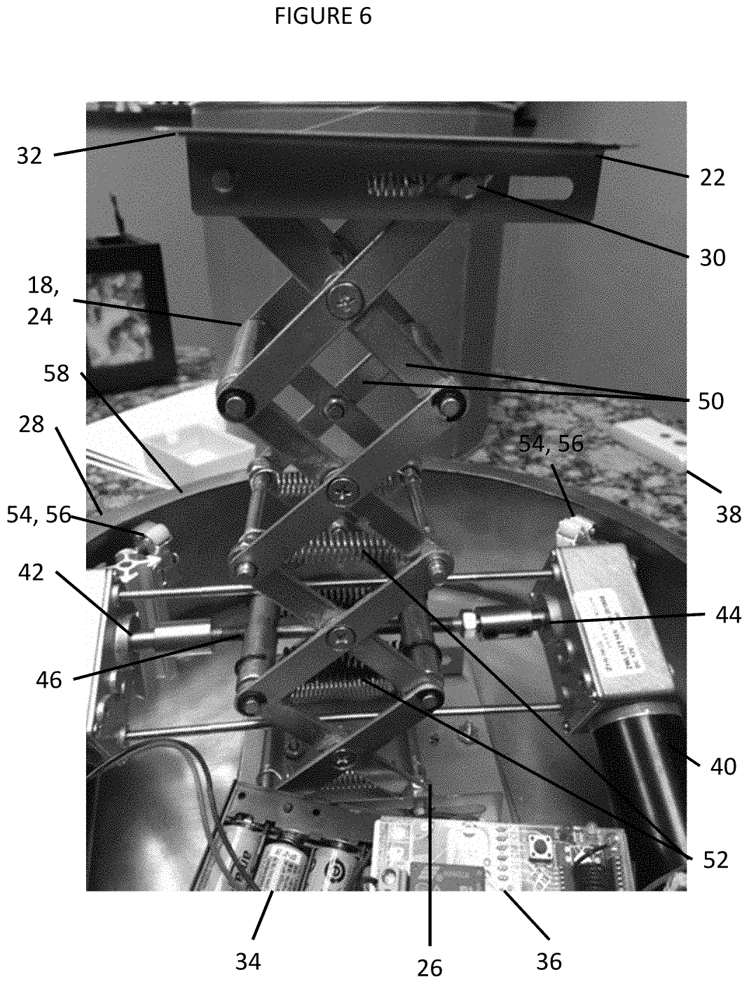

The lift mechanism 18 is powered by a power source 34 (such as batteries, rechargeable batteries, lithium ion batteries, or AC/DC power) and controlled with a control mechanism 36 situated any suitable place within the housing 28 that can be operated with a remote control 38. For example, the power source 34 can include eight 1.5 V batteries for a total of 12 V of electrical power. The control mechanism 36 includes any necessary circuitry and wiring for operating the ice cream lift 10. The remote control 38 (shown in FIG. 6) can operate by infrared, radio, wireless, Wi-Fi, Bluetooth, or any other suitable signals.

The lift mechanism 18 also includes at least one motor 40 that is connected to a distal end 42 and proximal end 44 of a threaded shaft 46 and in electrical connection with the power source 34. The threaded shaft 46 has opposing thread patterns, left hand thread on the distal end 42 and right hand thread on the proximal end 44. Attached to the threaded shaft 46 are two corresponding threaded nut axles 48 (left hand and right hand). Finally, the nut axles 48 are connected to two sequences of alternating direction and position pivot arms 50, forming the mechanics of the scissors lift 24.

When the remote control 38 is activated, the power source 34 begins supplying torque and power via 12V electric motors 40 through the threaded shaft 46. The rotation of the threaded shaft 46 within the nut axles 48 causes the nut axles 48 to draw closer when rotated in one direction and push apart when rotated in the opposite direction. The movement of the nut axles 48 causes the sequences of pivot arms 50 to lift and lower. The remote control 38 can include directional buttons to raise and lower the pivot arms 50.

Supporting the lifting power needs on the low end of the process are a series of springs 52, operatively connected to the nut axles 48. The springs 52 pull on the nut axles 48, relieving some of the pressure of the weight of the load. Any number of springs 52 can be used.

The housing 28 can further include a plurality of catches/latches 54 used to secure the ice cream container 16 in place. The catches 54 are preferably spring loaded compression rollers 56. The container 16 can be pushed down between the rollers 56, thereby pinching walls 60 of the container 16 and a metal band 70 (i.e. an annular rim) that secures the base 14 to the walls 60 between the rollers 56. The catches 54 are preferably located below a rim 58 of the housing 28. The FIGURES show four catches 54, but any suitable number can be used. The platform 12 preferably has a diameter slightly smaller than that of the rim 58 to allow the walls 60 and metal band 70 to fit therebetween to engage with the catches 54. The catches 54 can clamp the metal band 70 in place, and as the platform 12 raises against the base 14, the base 14 dissociates from the metal band 70 and is raised up along the walls 60 of the container 16.

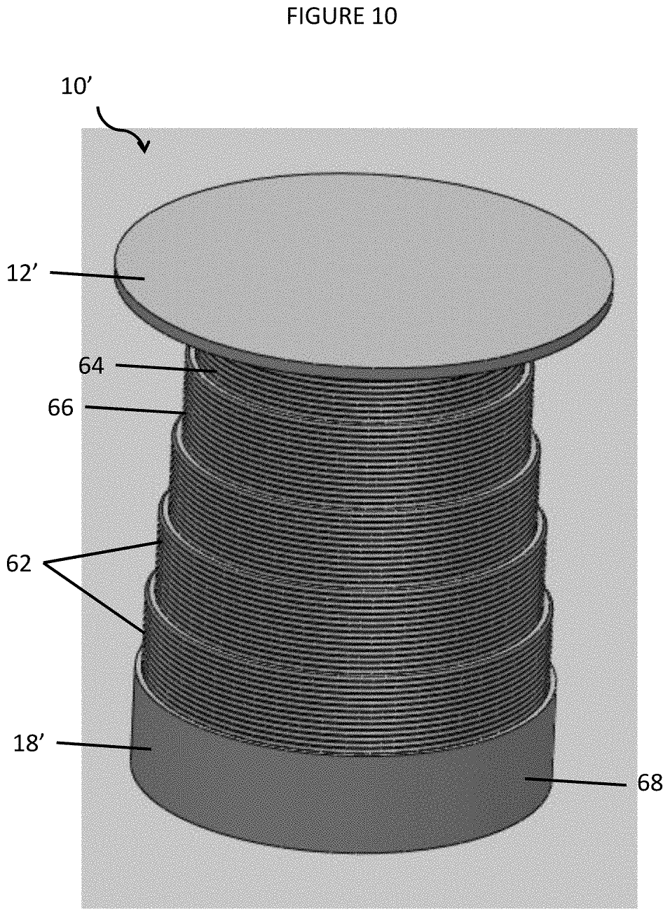

In a second embodiment, shown in FIG. 10, the ice cream lift 10′ includes a platform 12′ operatively connected to a lift mechanism 18′ that is a plurality of interlocking concentric threaded rings 62. This embodiment translates a rotating motion into a lifting motion. A motor (such as a gear, step, or any other suitable motor) including a drive shaft is operatively connected to a smallest ring 64, which is also operatively connected to the platform 12′. The smallest ring 64 is threaded with a next larger concentric ring 66, and subsequent concentric rings 62, up through a largest concentric ring 68. In other words, each ring 62 is nested within another ring 62 and in threaded connection. Actuation of the step motor while holding the largest ring 68 in a fixed position causes the smallest ring 64 to rotate until the threading hits a stop, beginning the rotation of the next larger ring 66, and this process continues until each ring 62 is raised and separated.

This embodiment can also include any features described above for the first embodiment, such as features of the platform 12′ to aid in dissociating the base 14 from the ice cream container 16, the remote control 38 for operation, and any power source 34 and control mechanism 36.

The present invention provides for a method of lifting a base 14 of an ice cream container 16, by contacting the base 14 with a platform 12 of an ice cream lift 10, detaching the base 14 from sides or walls 60 of the ice cream container 16, and driving the platform 12 and base 14 upwards to a higher position within the ice cream container 16.

The detaching step can be performed by dissociating the base 14 from a metal rim 70, breaking perforations around the base 14, cutting the base 14 away from walls 60 of the ice cream container 16, or any other suitable method of detaching.

The method can further include securing the ice cream container 16 in place with catches along a rim 58 of a housing 28 of the ice cream lift 10. The driving step can be accomplished with the first embodiment by activating a remote control 38, supplying torque and power via motors 40 to rotate a threaded shaft 46, causing nut axles 48 push apart when rotated in a first direction, and causing sequences of pivot arms 50 to lift the platform 12 and base 14 to a higher position. The method can further include lowering the platform 12 and base 14 by activating a remote control 38, supplying torque and power via motors 40 to rotate a threaded shaft 46, causing nut axles 48 to draw together when rotated in a second direction, and causing sequences of pivot arms 50 to lower the platform 12 and base 14 to a lower position.

The driving step can alternatively with the second embodiment include driving concentric threaded rings 62 in an upward motion, thereby raising the platform 12′ as described above.

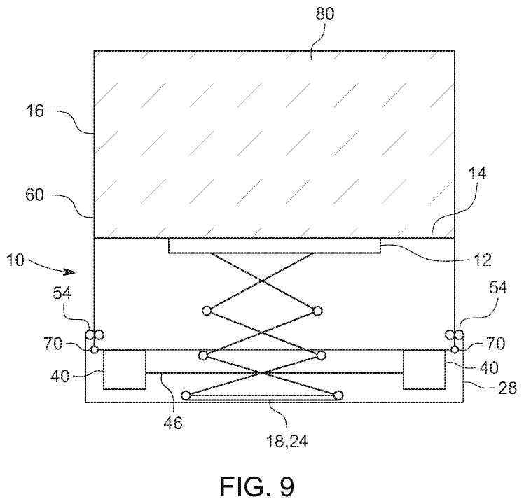

By performing this method, ice cream 80 within the container 16 can be raised upwards to ease scooping and serving, as shown in FIG. 9. This also makes the product look better to the customer, and reduces contamination from the server continually placing their whole arm into the container 16. The ice cream lift 10 and 10′ is also advantageous because it can be used in a confined space.

While the invention is described as being used with an ice cream container, it should be understood that it can be used with any type of container that has a base that can be detached and raised within the container, and the container can contain any type of food or other items.

Therefore, the present invention provides for a container lift 10, including a platform 12 that contacts and pushes up a base 14 of a container 16, the platform 12 operatively connected to a lift mechanism 18 that drives the platform 12 from a first position 20 to a second higher position 22.

The present invention also provides for a method of lifting a base 14 of a container 16, by contacting the base 14 with a platform 12 of a container lift 10, detaching the base 14 from sides of the container 16, and driving the platform 12 and base 14 upwards to a higher position within the container 16.

Throughout this application, various publications, including United States patents, are referenced by author and year and patents by number. Full citations for the publications are listed below. The disclosures of these publications and patents in their entireties are hereby incorporated by reference into this application in order to more fully describe the state of the art to which this invention pertains.

The invention has been described in an illustrative manner, and it is to be understood that the terminology, which has been used is intended to be in the nature of words of description rather than of limitation.

Obviously, many modifications and variations of the present invention are possible in light of the above teachings. It is, therefore, to be understood that within the scope of the appended claims, the invention can be practiced otherwise than as specifically described.

What is claimed is:

1. An ice cream lift, comprising a platform that contacts and pushes up a base of an ice cream container, said platform operatively connected to a lift mechanism that drives said platform from a first position to a second higher position.

2. The ice cream lift of claim 1, wherein said platform is flat and circular in shape to match said base.

3. The ice cream lift of claim 1, wherein said lift mechanism is a scissor lift operatively attached at a proximal end within a housing, and at a distal end to a support that holds and contacts said platform.

4. The ice cream lift of claim 3, wherein said lift mechanism is powered by a power source and controlled with a control mechanism within said housing.

5. The ice cream lift of claim 4, wherein said power source is chosen from the group consisting of batteries, rechargeable batteries, lithium ion batteries, and AC/DC power.

6. The ice cream lift of claim 3, wherein said lift mechanism is operable by a remote control.

7. The ice cream lift of claim 6, wherein said remote control is operated by signals chosen from the group consisting of infrared, radio, wireless, Wi-Fi, and Bluetooth.

8. The ice cream lift of claim 3, wherein said lift mechanism includes motors connected to a distal end and proximal end of a threaded shaft and in electrical connection with said power source.

9. The ice cream lift of claim 8, wherein said threaded shaft includes a left hand nut axle and a right hand nut axle connected to two sequences of alternating direction and position pivot arms.

10. The ice cream lift of claim 9, further including springs operatively connected to said left hand nut axle and said right hand nut axle.

11. The ice cream lift of claim 9, wherein by said power source supplying power to said motors to rotate said threaded shaft, said left hand nut axle and said right hand nut axle draw closer together, causing said pivot arms to lift.

12. The ice cream lift of claim 3, wherein said housing further includes a plurality of catches below a rim of said housing for securing said ice cream container.

13. The ice cream lift of claim 12, wherein said catches are further defined as spring loaded compression rollers that pinch walls and a metal rim of said ice cream container.

14. The ice cream lift of claim 1, wherein said lift mechanism is a plurality of interlocking concentric threaded rings.

15. The ice cream lift of claim 14, wherein a smallest ring is operatively connected to a step motor including a drive shaft and said platform, and said smallest ring is threaded with a next larger concentric ring.

16. The ice cream lift of claim 15, wherein actuation of said step motor causes said smallest ring to rotate until its threading hits a stop and causes rotation of said next larger concentric ring, until each said ring is raised and separated and said platform is in said second higher position.

17. A method of lifting a base of an ice cream container, including the steps of:
contacting the base with a platform of an ice cream lift;
detaching the base from sides of the ice cream container; and
driving the platform and base upwards to a higher position within the ice cream container.

18. The method of claim 17, further including the step of securing the ice cream container in place with catches along a rim of a housing of the ice cream lift.

19. The method of claim 17, wherein said driving step is performed by activating a remote control, supplying torque and power via motors to rotate a threaded shaft in the ice cream lift, causing nut axles push apart when rotated in a first direction, and causing sequences of pivot arms to lift the platform and base to a higher position.

20. The method of claim 17, further including the steps of lowering the platform and base by activating a remote control, supplying torque and power via motors to rotate a threaded shaft, causing nut axles to draw together when rotated in a second direction, and causing sequences of pivot arms to lower the platform and base to a lower position.

21. The method of claim 17, wherein said driving step is performed by driving concentric threaded rings in an upward motion, thereby raising the platform.

22. The method of claim 21, wherein a step motor causes a smallest ring to rotate until its threading hits a stop and causes rotation of a next larger concentric ring, until each ring is raised and separated and the platform is in the higher position.

23. The method of claim 17, wherein said detaching step is further defined as a step chosen from the group consisting of dissociating the base from a metal rim, breaking perforations around the base, and cutting the base away from walls of the ice cream container.

24. A container lift, comprising a platform that contacts and pushes up a base of a container, said platform operatively connected to a lift mechanism that drives said platform from a first position to a second higher position.

25. A method of lifting a base of a container, including the steps of:
contacting the base with a platform of a container lift;
detaching the base from sides of the container; and
driving the platform and base upwards to a higher position within the container.
